(19) United States
(12) Patent Application Publication
(10) Pub. No.: US 2026/0154803 A1
(43) Pub. Date: Jun. 4, 2026

(54) PREDICTIVE MAINTENANCE USING DUAL-STAGE GENERATIVE AI ANALYSIS OF OPTICAL SENSOR DATA

(71) Applicant: Odysight.ai Ltd., Omer (IL)

(72) Inventor: Amit SULTAN, Beer Sheva (IL)

(73) Assignee: Odysight.ai Ltd., Omer (IL)

(21) Appl. No.: 19/405,560

(22) Filed: Dec. 2, 2025

Related U.S. Application Data
(60) Provisional application No. 63/726,700, filed on Dec. 2, 2024.

(51) Int. Cl. G06T 7/00

(52) U.S. Cl. CPC G06T 7/0004; G06T 2207/20081; G06T 2207/30164

(57) ABSTRACT

A system and method for predictive maintenance of operational mechanisms using dual-stage artificial intelligence analysis of optical sensor data. The system comprises optical sensors capturing images, a hardware interface, and a processor implementing two specialized AI models: a first model generating structured technical captions describing physical conditions, and a second model identifying mechanical anomalies from these captions. The system features dynamic control parameter modification, automatically implementing adjusted operational parameters based on detected anomalies until maintenance completion. Real-time severity assessment enables quantitative evaluation with automatic threshold modifications to prevent mechanical failure. The system generates comprehensive maintenance alerts including technical specifications, sensor data, time-to-failure predictions, and maintenance procedures. Implementation options include local, cloud-based, or hybrid processing configurations. Applications span critical transportation systems, defense platforms, and industrial equipment, providing continuous monitoring, predictive maintenance, and automated control adaptation to prevent equipment failure.

### RELATED APPLICATION(S)

This application claims the benefit of priority under 35 USC § 119(e) of U.S. Provisional Patent Application No. 63/726,700 filed on Dec. 2, 2024, the contents of which are incorporated by reference as if fully set forth herein in their entirety.

### FIELD AND BACKGROUND OF THE INVENTION

The present invention relates generally to the field of predictive maintenance for operational mechanisms. More specifically, the invention pertains to methods and systems for monitoring, analysis, and prediction of operational states in mechanisms to enable proactive maintenance and prevent failures.

In industrial, manufacturing, and various other operational environments, the reliability and efficiency of mechanical systems are crucial for maintaining productivity and minimizing downtime. Traditional maintenance approaches often rely on scheduled interventions or reactive measures after a failure has occurred. However, these methods can lead to unnecessary maintenance costs, unexpected breakdowns, and significant operational disruptions.

Predictive maintenance has emerged as a more advanced approach, aiming to anticipate and prevent failures before they occur. Early predictive maintenance systems typically relied on periodic data collection and offline analysis, which limited their ability to detect and respond to rapidly developing issues.

With the advent of Internet of Things (IoT) technologies, data collection from operational mechanisms has become more feasible.

### SUMMARY OF THE INVENTION

According to an aspect of some embodiments of the present invention, there is provided a computer-implemented system for predictive maintenance of an operational mechanism. The system includes a hardware interface configured for receiving images of at least a portion of the operational mechanism captured by optical sensors. The system further includes a processor operatively coupled to receive the images through the hardware interface. The processor implements a dual-stage artificial intelligence analysis where a first generative AI model analyzes the images to generate structured technical captions describing physical conditions of the operational mechanism, and a second generative AI model processes these captions to identify mechanical anomalies that deviate from baseline operational parameters. The system includes a presentation unit that receives presentation instructions from the processor to display alerts and/or maintenance notifications indicative of the identified mechanical anomalies.

Optionally, the processor may dynamically generate maintenance instructions for the operational mechanism based on the identified mechanical anomalies. Optionally, the processor may dynamically generate modified control parameters for the operational mechanism until such maintenance instructions are performed in order to avoid further damage to the operational mechanism. In such embodiments, these modified control parameters may be automatically implemented to adjust operation until maintenance completion, helping prevent damage to the operational mechanism.

Optionally, the images may be captured in real-time during operation of the operational mechanism, enabling continuous monitoring of mechanical conditions.

Optionally, the first generative AI model may be trained using a training dataset that comprises one or more of: mechanical system images, synthetic data, or textual descriptions of mechanical conditions. Similarly, in some embodiments, the second generative AI model may be trained using a fault dataset comprising one or more of: historical fault data, synthetic fault descriptions, or predefined anomaly patterns.

Optionally, the processor may calculate real-time likelihood of mechanical failure based on various factors including the identified anomalies, environmental sensor data, operational schedules, usage characteristics of the operational mechanism, characteristics of a user of the operational mechanism and historical maintenance data. In such embodiments, the processor may generate and output predicted time to failure and optionally suggested control parameters to delay the failure. The control parameters may be automatically adjusted based on this calculated likelihood to maintain safe operation.

In some embodiments, the processor may determine quantitative severity levels of identified anomalies based on measured deviations from baseline parameters, detected impact on mechanical functions, and environmental conditions. According to such embodiments, operational thresholds may be automatically modified based on these severity levels to prevent mechanical failure.

Optionally, the system may present the determined quantitative severity levels through the presentation unit, providing clear visualization of the severity assessment.

Optionally, the system may generate comprehensive maintenance alerts comprising technical specifications, sensor data indicating severity levels, time-to-failure predictions based on current operational data, and/or required maintenance procedures. In such embodiments, these alerts may be automatically added to maintenance notifications or transmitted to maintenance control systems.

Optionally, the system may predict when identified anomalies are likely to lead to mechanical failure based on known future environmental parameters and operational schedules, enabling proactive maintenance planning.

In some embodiments, the system may generate and maintain dynamic models of proper mechanism functioning, with periodic retraining using images collected during actual operation to maintain accuracy over time.

Optionally, the system may provide specific operating instructions for detected fault conditions, including abort criteria, modified operational parameters, and emergency procedures.

Optionally, the system may implement foreign object detection capabilities, where the first generative AI model identifies foreign objects in proximity to the operational mechanism, and the second model assesses associated risk levels. In such embodiments, maintenance notifications may include specific foreign object removal procedures.

Optionally, the system may include baseline model generation components, periodic retraining mechanisms, data validation components, and model optimization components to maintain and improve system performance over time.

Each of these embodiments represents potential implementations and enhancements to the base system, providing flexibility in deployment while maintaining the core dual-stage AI analysis approach for predictive maintenance. The specific combination of these optional features can be selected based on particular application requirements and operational contexts.

Each of these embodiments further provides a computer-implemented method implementing the above capabilities through corresponding method steps, enabling the same predictive maintenance functionality through procedural implementation.

Some embodiments of the present invention provide practical applications and technological advantages in the field of predictive maintenance. According to an aspect of some embodiments of the present invention, the dual-stage generative AI architecture addresses real-world maintenance challenges that have economic and operational impacts across multiple industries.

In some embodiments, the ability to convert visual data into structured technical descriptions through the first generative AI model, followed by automated anomaly detection through the second model, enables maintenance teams to identify and address potential failures before they occur. This represents a technological advancement over traditional maintenance approaches that rely on either scheduled inspections or simple sensor threshold monitoring or image subtraction. For example, in aircraft maintenance applications, according to some embodiments, the system can detect changes in landing gear compression patterns that might indicate early-stage bearing wear, enabling targeted maintenance interventions before safety-critical failures develop. In manufacturing environments, according to some embodiments, monitoring production equipment through optical sensors and AI analysis can reduce unplanned downtime by identifying degradation patterns before conventional monitoring systems. Another potential advantage of some embodiments of the invention relates to the reduction on false detection of failures due to a more accurate analysis of the images using said generative AI models. When image subtraction is used false detection of failures may occur for example when an optical lens is covered with dirt or when the image changes because of reasons not related to actual wear or damage to the monitored object. Using embodiments of the present invention may prevent such false detection and also allows assure detection of slowly developing damage which is missed in some dynamic image subtraction processes.

According to an aspect of some embodiments of the present invention, the technological solution provides distinct advantages that enable these practical applications. In some embodiments, the dual-stage AI architecture reduces false positives compared to single-stage systems by separating the tasks of visual analysis and anomaly detection. This separation allows each model to be optimized for its specific task. In some embodiments, the ability to generate structured technical captions creates an interpretable intermediate format that maintenance personnel can review and verify, addressing the “black box” problem common in AI-based systems. This transparency may enable maintenance teams to make informed decisions based on the system's recommendations, leading to more efficient resource allocation and reduced unnecessary maintenance interventions.

According to some embodiments, real-time processing capabilities provide practical benefits in operational environments. In some embodiments, the ability to dynamically adjust control parameters based on detected anomalies enables automatic protective responses that can prevent failures while maintaining operational capability at reduced risk levels. For instance, in industrial manufacturing applications, according to some embodiments, machine operating parameters can be automatically adjusted upon detecting early-stage bearing wear, extending equipment life while maintaining production capability at optimized levels. This automated response capability represents an optional technological advancement over traditional monitoring systems that can only provide warnings without automated protective actions.

According to an aspect of some embodiments of the present invention, the practical applications extend beyond fault detection to maintenance optimization. In some embodiments, predicting time-to-failure based on current operational data and environmental conditions enables maintenance teams to schedule interventions during planned downtime, reducing the economic impact of maintenance activities. According to some embodiments, this predictive capability can reduce maintenance-related downtime compared to traditional scheduled maintenance approaches, while enabling condition-based rather than time-based maintenance scheduling.

According to some embodiments, the technological solution addresses the challenge of expertise scalability in maintenance operations. By encoding expert knowledge into the AI models'training datasets and implementing continuous learning capabilities, according to some embodiments, consistent monitoring across multiple installations can be achieved without requiring extensive human expertise at each location. This scalability advantage may have practical significance in industries facing skilled maintenance personnel shortages, enabling more efficient allocation of human expertise while maintaining maintenance quality standards.

According to an aspect of some embodiments of the present invention, detecting and classifying foreign objects through the same dual-stage AI architecture may provide practical advantages in operational safety and maintenance quality control. In some embodiments, the capability to automatically identify tools or debris left after maintenance procedures can reduce foreign object damage incidents for example in aerospace applications or surgical applications, representing a practical improvement in both safety and operational efficiency. According to some embodiments, this capability is enabled by the technological approach of using structured technical captions as an intermediate analysis step, allowing specific guidance for foreign object removal procedures rather than simple presence detection. As used herein, a ‘structured technical caption’ refers to a standardized textual description generated by the first generative AI model, comprising a systematic arrangement of observed mechanical conditions, including component identification, quantitative measurements, spatial references, and/or condition assessments, optionally formatted according to predefined templates to enable automated processing by the second generative AI model.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With structured reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic block diagram illustrating a system for predictive maintenance of an operational mechanism, constructed and operative in accordance with embodiments of the present invention;

FIG. 2A is an exemplary pre-operational image of a landing gear assembly captured by the system of FIG. 1, in accordance with embodiments of the present invention;

FIG. 2B is an exemplary image of the landing gear assembly showing a spider-shaped crack formation, captured by the system of FIG. 1, in accordance with embodiments of the present invention;

FIG. 3A is an exemplary image of a monitored component before a maintenance operation, captured by the system of FIG. 1, in accordance with embodiments of the present invention;

FIG. 3B is an exemplary image of the monitored component after the maintenance operation showing the presence of a foreign object, captured by the system of FIG. 1, in accordance with embodiments of the present invention; and

FIG. 4 is a flowchart illustrating a computer-implemented method for predictive maintenance of an operational mechanism, in accordance with embodiments of the present invention.

### DESCRIPTION OF STRUCTURED EMBODIMENTS OF THE INVENTION

The present invention relates generally to the field of predictive maintenance for operational mechanisms. More specifically, the invention pertains to a system and method for monitoring, analysis, and prediction of operational states in an operational mechanism using a plurality of optical sensors and artificial intelligence models to enable proactive maintenance and prevent failures.

Embodiments of this invention relates to challenges remain in effectively utilizing this data for predictive maintenance, for example:
1. Processing and analyzing large volumes of sensor data;
2. Accurately identifying patterns and anomalies that indicate potential issues;
3. Distinguishing between normal operational variations and true indicators of impending failures;
4. Providing timely and actionable insights to maintenance personnel; and/or
5. Adapting to different types of mechanisms and operational environments.

Existing solutions often struggle to address these challenges comprehensively. Many are limited in their ability to handle complex, multi-dimensional data optionally in real-time, are limited in their ability to accurately analyze differences between images, or require extensive manual configuration and domain expertise to implement effectively and there is thus a need for more advanced, flexible, and automated approaches to predictive maintenance that can one or more of:
1. Continuously monitor and analyze operational data from mechanisms;
2. Detect subtle patterns and anomalies that may indicate potential issues;
3. Accurately predict impending failures or maintenance needs;
4. Provide clear, actionable recommendations for maintenance interventions; or
5. Adapt to different types of mechanisms and operational contexts with minimal manual configuration.

Additional challenges in visual inspection and maintenance include one or more of:
1. Accurately identifying and classifying foreign objects in industrial environments;
2. Determining the severity and potential impact of detected foreign objects;
3. Differentiating between harmless environmental elements and hazardous foreign objects;
4. Providing clear, actionable guidance for foreign object removal procedures; or
5. Maintaining inspection accuracy despite variations in lighting and optical sensor positioning.

The embodiments of the present invention address these needs by providing a computer-implemented method and system for predictive, optionally real-time, maintenance of operational mechanisms. By leveraging data processing techniques, machine learning algorithms, and optionally a flexible, modular architecture, the invention enables more accurate and timely prediction of maintenance needs while reducing the need for manual intervention and mechanism-specific customization.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

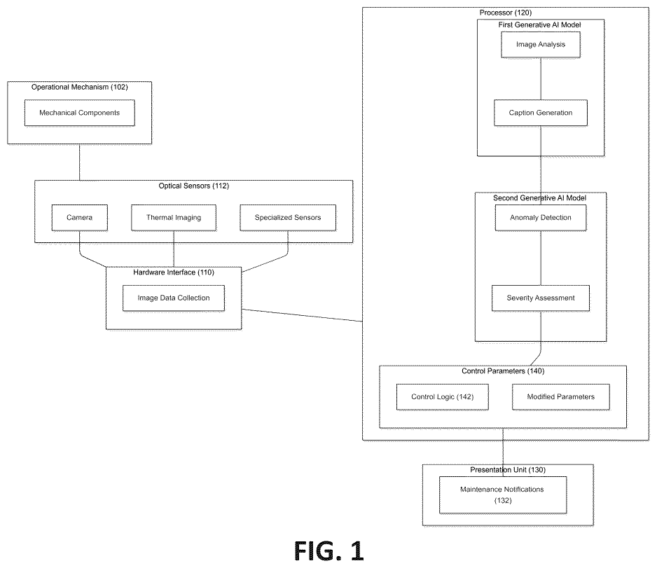

Referring now to the drawings, FIG. 1 that illustrates a system (100) for predictive maintenance of an operational mechanism (102), which can be implemented for example across various critical transportation and defense platforms. The system employs advanced computer-vision monitoring and multi-stage artificial intelligence analysis to detect and predict mechanical anomalies before component failure occurs. As used herein, an ‘operational mechanism’ refers to any system, entity, or structure that exhibits a set of operational parameters, processes, or functions, which can be monitored, assessed, or analyzed for performance, condition, or anomalies. In some embodiments, operational mechanism may refer to any mechanical, electromechanical, or mechatronic system subject to wear, stress, or potential failure during operation, including but not limited to industrial equipment, transportation systems, manufacturing machinery, and defense platforms, which can be monitored through optical sensors for maintenance purposes.

The operational mechanism (102) may include one or more industrial components, vehicular components and/or infrastructure systems. In vehicular applications, this includes aircraft systems such as turbine engines, landing gear assemblies, and control surfaces; marine vessel components including propulsion systems, steering mechanisms, and hull integrity points; and surface vehicle elements comprising transmission systems, brake assemblies, and suspension components. The industrial components may also include one or more of cables, straps, bearings such as ball-bearings and elastomeric bearings, springs, valves, screws and nuts.

In some embodiments, operational mechanism may be applicable to bodies of mammals or human beings whose physiological or functional states may be evaluated using similar monitoring principles. In such embodiments, the system may be used to detect any anomalies within the body, anomalies during a surgical procedure and/or identify foreign object within a body, for example accidentally left in the body after a surgical procedure.

The system (100) includes a hardware interface (110) that receives images from one or more optical sensors (112). The optical sensor(s) may comprise camera(a), high-speed thermal imaging camera(s) for heat pattern analysis, vibration-resistant high-resolution optical sensors, specialized millimeter-wave imaging systems, impact-resistant underwater cameras for marine applications, and/or environmental-hardened infrared sensors for night operations. These sensors (112) may be mounted at inspection points around the operational mechanism (102), such as engine compartments, mounting points, structural stress zones, critical joint assemblies, and load-bearing components.

The system (100) further includes a processor (120) which is operatively coupled to receive outputs of the optical sensor(s) (112) through the hardware interface (110). The processor (120) implements two specialized artificial intelligence models: a first generative AI model (122) and a second generative AI model (124).

As used herein a generative AI model is a function trained using machine learning technical to receive inputs such as text, image, audio, video, and code and generate new content into any of defined modalities. For example, it can turn text inputs into an image, turn an image into a text, or turn video into text. One example of a language-based generative model is a large language model (LLM). Another example is a model adapted for creation of text describing 2D images, 3D images, videos, graphs, and other illustrations. Generative AI models can create graphs, realistic images, produce 3D models, logos, enhance or edit existing images, and the like. Another example is a model adapted for generating synthetic data to train generative AI models when data doesn't exist.

As used herein one or more images may be a set of still images and/or a video file including a plurality of frames as images.

The first generative AI model (122) analyzes the received images to generate structured technical captions describing what is imaged, namely the operational mechanism, and when present also anomalies reflected in the physical condition of the operational mechanism. These captions may detail critical observations such as thermal anomalies detected in rotating mechanical assemblies, developing structural deformations in load-bearing components at identified coordinates, accelerated wear patterns detected in critical sealing mechanisms, and/or deviation from normal motion profiles observed in precision positioning systems. The captions may systematically describe both visible and latent degradation indicators that may be imperceptible to standard visual inspection methods, providing quantifiable data points that serve as early indicators of potential system failures. Specific example of these captions can be abnormal thermal signatures detected in port-side turbine bearing assemblies, microfracture patterns developing in primary mounts at specific coordinates, excessive wear detected on submarine propeller shaft seals, and irregular oscillation patterns observed in missile launcher elevation mechanisms.

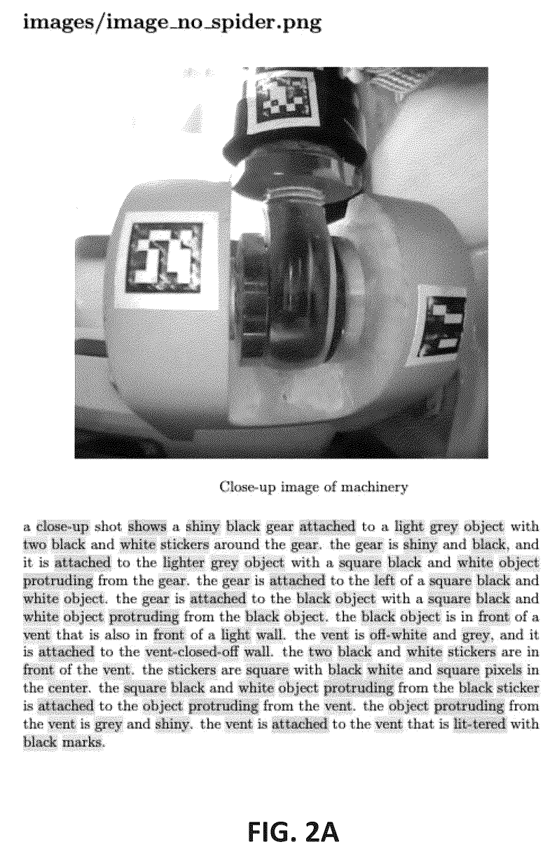

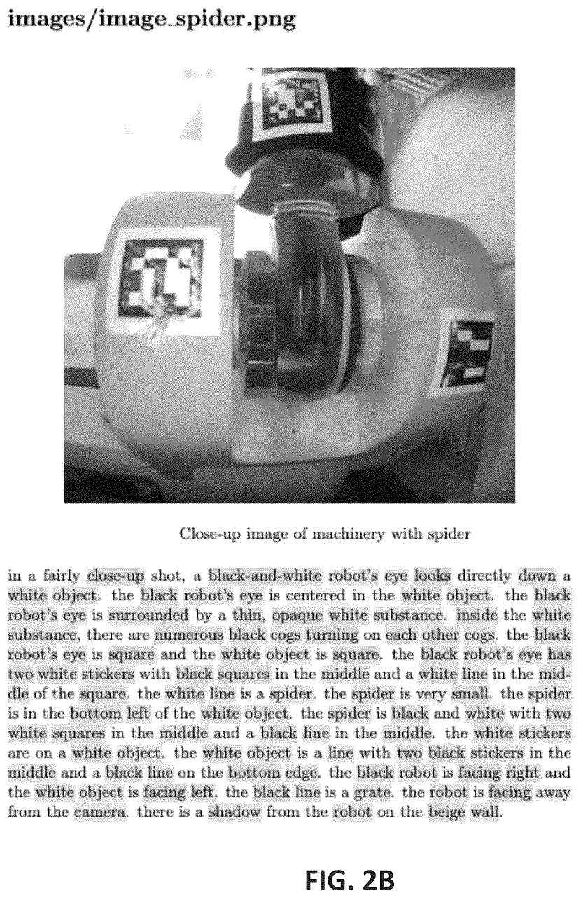

For example, FIG. 2A depicts an image of a landing gear and FIG. 2B depicts the same gear with a spider on the landing gear. Exemplary captions generated using the generative model are provided below each image.

The second generative AI model (124) processes these captions to identify anomalies that deviate from established baseline parameters. The generative AI model evaluates operational variations exceeding design specifications, geometric deviations beyond engineered tolerances, dynamic behavior patterns indicating potential component degradation, and material wear characteristics suggesting deterioration of functional integrity. Through multivariate analysis, the generative AI model correlates these deviations against established performance envelopes to quantify the significance of observed anomalies and their potential impact on system reliability. Specific examples of mechanical anomalies that deviate from established baseline parameters can be temperature variations exceeding standard specifications, structural deformations beyond acceptable tolerances, vibration patterns indicating imminent component failure, and wear patterns suggesting compromised operational integrity. In this case the spider is identified and may be ignored as not suggesting deterioration of functional integrity.

The processor may execute foreign object detection (FOD) process through enhanced image analysis. The first generative AI model may be trained to generate captions that include detailed descriptions of any expected objects, unexpected and when present foreign objects in the monitored area. For example, when analyzing images of landing gear assemblies, the generative AI model can identify and describe objects such as tools left after maintenance or biological contaminants like spider webs. The second generative AI model is configured to analyze these captions with particular attention to foreign object classification and risk assessment. The generative AI model evaluates factors such as:
The nature and identity of detected foreign objects;
Potential impact on system operation;
Required removal or mitigation procedures; or
Safety implications of the foreign object's presence.
   This dual-model approach may provide several advantages over traditional image comparison methods:
1. Objects are not only detected but also classified and contextualized;
2. The system can provide specific guidance on removal procedures;
3. Risk assessments are based on object identification rather than just visual differences;
4. Analysis remains accurate despite minor variations in image alignment or lighting conditions; and/or
5. The system can distinguish between harmless environmental elements and potentially hazardous foreign objects.

The training procedure for the generative AI models may comprise multiple structured phases. For example, initial training phase may comprise for example:
Minimum dataset size: 100,000 annotated mechanical system images;
Validation split: 20% of dataset reserved for validation;
Training iterations: Minimum 1,000 epochs or until convergence threshold of 0.001; and/or
Learning rate: Dynamic adjustment between 1e-3 and 1e-5 based on validation loss.
   Specialized Training Elements may comprise for example:
Synthetic data augmentation: Minimum 50% of training data;
Domain-specific feature extraction: Minimum 1,000 mechanical failure patterns;
Cross-validation: 5-fold validation with maximum 2% variance tolerance; and/or
Transfer learning: Pre-training on general mechanical system dataset of minimum 1,000,000 images.
   Continuous Learning Implementation may comprise for example:
Update frequency: Every 1,000 operational hours or 30 calendar days;
Minimum new data requirement: 1,000 validated samples per update;
Performance regression testing: Maximum 0.1% accuracy degradation allowed; and/or
Model version control: Maintaining previous three versions for fallback.

The system may include a presentation unit (130), optionally MIL-SPEC compliant, that receives presentation instructions from the processor (120) and displays maintenance notifications (132) to operators, maintenance crews, or command personnel. These notifications encompass mission-critical alerts, combat readiness status updates, maintenance priority classifications, operational risk assessments, and recommended field repair procedures.

In operation, the system (100) may continuously monitor the operational mechanism (102) through real-time image capture and analysis, even under extreme environmental conditions or combat situations. When potential issues are detected, the system can immediately alert relevant personnel through the presentation unit (130), initiate automated safety protocols, recommend mission continuation/abort criteria, and suggest tactical alternatives based on equipment status.

The system's robust architecture may be specifically designed to operate in demanding heavy-duty applications where equipment failure could result in mission compromise, personnel safety risks, catastrophic system failure, or strategic capability loss. This predictive approach significantly enhances combat readiness, mission success rates, equipment longevity, maintenance efficiency, and operational safety margins.

The system provides several technical advantages over conventional maintenance approaches. First, the dual-stage AI processing architecture, utilizing two distinct generative AI models in sequence, enables more accurate anomaly detection compared to single-stage analysis systems. The first model's specialization in generating structured technical captions acts as a filter, converting complex visual data into standardized, analyzable descriptions, while the second model's focus on anomaly detection allows for specialized training in fault recognition without being encumbered by the complexity of raw image processing.

Furthermore, the system's ability to detect and quantify latent degradation indicators—subtle signs of wear or damage that precede visible deterioration—enables predictive maintenance rather than merely preventive or reactive maintenance. This capability is particularly for critical components where failure progression can be rapid once visible symptoms appear. The system's continuous real-time monitoring capability, combined with its ability to correlate multiple types of degradation indicators, provides a more comprehensive and reliable assessment of mechanical health than periodic manual inspections or single-sensor monitoring systems.

The system also offers advantages in terms of scalability and adaptability. Its modular architecture allows for easy integration of additional sensors and updating of AI models without fundamental system redesign. The use of structured technical captions as an intermediate data format provides a standardized way to document and analyze mechanical conditions across different types of equipment and operational contexts, enabling knowledge transfer and pattern recognition across different installations of the system. This standardization also facilitates the continuous improvement of the system's predictive capabilities through the aggregation and analysis of historical data across multiple deployments.

Additionally, in some embodiments, the system (100) implements advanced control adaptation capabilities through the processor (120). Specifically, the processor (120) may be configured to dynamically generate modified control parameters (140) for the operational mechanism (102) based on the identified mechanical anomalies. These modified control parameters may include adjusted operational limits, modified performance envelopes, and compensatory control settings designed to maintain safe operation while minimizing further degradation. As used herein, ‘control parameters’ refers to adjustable operational settings and limits that govern the functioning of the operational mechanism, including but not limited to speed limits, load restrictions, temperature thresholds, pressure ranges, and operational duty cycles, which can be modified to maintain safe operation when anomalies are detected.

In such embodiments, the processor (120) optionally includes an automatic control implementation logic (142) that interfaces with the operational mechanism's control systems to automatically implement these modified control parameters. This implementation may occur in real-time and remains in effect until the completion of necessary maintenance actions. For example, if the system detects bearing wear in a rotating assembly, it might automatically reduce maximum rotational speeds or adjust load distribution patterns. Similarly, in response to detected structural stress patterns, the system might modify acceleration limits or restrict operational ranges to prevent damage escalation.

This adaptive control capability may provide a critical bridge between anomaly detection and maintenance execution, actively protecting the operational mechanism during the period between issue identification and repair completion. The ability to automatically adjust operational parameters based on real-time condition assessment represents a significant advancement over traditional binary (operational/non-operational) monitoring systems, enabling a more nuanced approach to equipment preservation and risk management.

The automatic implementation of modified control parameters may serve multiple technical functions. It may help preventing the progression of detected anomalies into more serious failures, extending the operational lifespan of affected components when immediate maintenance is not possible, and maintaining operational capability at reduced risk levels when complete shutdown is not desirable or practical. This capability is particularly in mission-critical applications were maintaining some level of operational capability, even if degraded, may be preferable to complete system shutdown.

In some embodiments, the optical sensor(s) (112) are configured to capture images during actual operation of the operational mechanism (102). This capture capability enables dynamic monitoring of the operational mechanism under actual load conditions, stress patterns, and operational cycles. The system processes these images continuously as they are captured, providing immediate analysis of developing conditions rather than relying on periodic or static inspections.

In some embodiments, the system implements direct mechanical control through a control interface architecture that establishes bidirectional communication with the operational mechanism's control systems. When mechanical anomalies are detected, in some embodiments, the automatic control implementation logic executes a multi-stage parameter adjustment process:

First, the processor calculates specific quantitative modifications to operational parameters based on detected anomaly characteristics, for example, reducing rotational speeds by a calculated percentage when bearing wear patterns are detected, or adjusting load distribution patterns when structural stress exceeds defined thresholds.

These modifications are then translated into machine-level control commands compatible with the operational mechanism's control systems. The automatic control implementation logic validates each parameter modification against safety constraints before transmission, ensuring controlled parameter transitions that prevent sudden operational changes. The system maintains continuous feedback monitoring during parameter adjustment implementation, measuring the operational mechanism's response to each modification through the optical sensors and adjusting the parameters iteratively if necessary.

This closed-loop control architecture enables the system to prevent failure progression through precise, measured adjustments to operational parameters. For example, when the system detects early-stage bearing wear through thermal pattern analysis, it can automatically implement a graduated reduction in maximum rotational speeds, adjust acceleration/deceleration profiles to reduce stress on the affected components, and modify load distribution patterns to minimize wear progression. The system may log all parameter modifications and their resulting effects on the detected anomalies, enabling continuous optimization of the control response patterns. This automated control implementation may have measurable impact in industrial applications, for instance it may reduce unplanned downtime by automatically adjusting operational parameters when early-stage wear patterns are detected, thereby extending component life while maintaining operational capability at optimized levels until scheduled maintenance can be performed.

In embodiments where imaging is performed during operation of the operational mechanism, this imaging capability can be particularly significant because it may allow the system to detect and analyze transient phenomena that might be missed during static or scheduled inspections. For instance, the system can capture momentary deformations under peak loads, thermal patterns during maximum stress conditions, or vibration effects that only manifest during specific operational states. The continuous stream of images may enable the system to build a comprehensive understanding of the operational mechanism's behavior across its full range of operational conditions and cycles.

The nature of the image capture during operation of the operational mechanism also facilitates immediate correlation between observed anomalies and operational conditions, enabling more accurate identification of cause-and-effect relationships between operational parameters and mechanical degradation patterns. This temporal correlation capability enhances both the accuracy of anomaly detection and the effectiveness of the system's predictive capabilities.

In particular implementations, the optical sensor(s) (112) are configured to capture images before or after the actual operation of the operational mechanism (102). When a pre-operation imaging logic is executed by the processor the optical sensors are activated prior to system startup to establish baseline condition documentation. This pre-operation imaging sequence captures detailed visual data of critical components in their rest state, enabling detection of any static anomalies such as visible wear patterns, structural deformations, or alignment issues that might impact upcoming operations. When a post-operation imaging logic is executed by the processor comprehensive visual data is captured after system shutdown, but while components are still in their thermally-stressed state. This timing can be particularly advantageous as it may enable detection of thermal-related anomalies, residual deformations, or other conditions that might only be apparent immediately following operation. The post-operation imaging sequence can be specifically timed to capture data during the cool-down phase, when thermal gradients can reveal underlying structural or mechanical issues not visible during either operation or complete rest states.

In particular implementations, the optical sensor(s) (112) are configured to capture images before and after the actual operation of the operational mechanism (102). In this embodiment a differential analysis may be applied by the processor to compare the pre-and post-operation images to identify any changes that occurred during the operational cycle. This comparative analysis is particularly for detecting:
Progressive wear patterns that develop during each operational cycle;
Thermal stress effects that persist after operation;
Temporary deformations that might indicate developing structural issues;
Changes in surface conditions that might indicate material degradation; and/or
Subtle alignment shifts that could suggest mounting or support structure issues.

The combination of pre-operation and post-operation imaging may provide data points for tracking the cumulative effects of operational cycles on system components, enabling early detection of developing issues before they become apparent during actual operation.

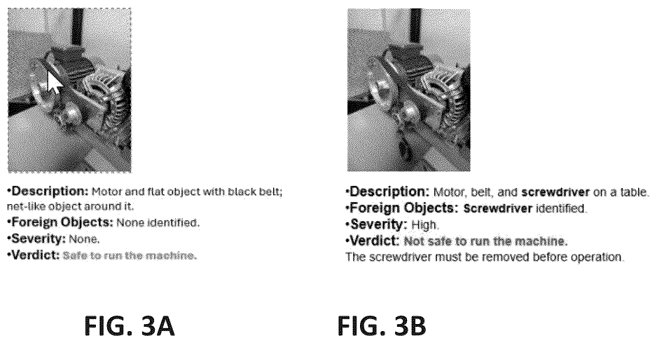

For example, FIGS. 3A and 3B are two images, one depicting a monitored component before a maintenance operation and the other after the maintenance operation. In this case the post-operation imaging analysis allows identifying a presence of a new object, even without having a black list defining undesired objects or a white list defining desired objects in the images during the pre-operation imaging. The screwdriver can be identified as an undesired object by querying a module such as an LLM module about the severity of such an object in proximity to an operational mechanical system.

Optionally, the training dataset used to train the first generative AI model (122) comprises a comprehensive collection of data sources specifically selected to ensure robust and accurate analysis capabilities. This training dataset includes mechanical system images capturing various operational states, wear patterns, and failure modes across different types of equipment. The dataset further incorporates synthetic data generated through advanced simulation techniques, providing coverage of edge cases and rare failure modes that might be impractical or impossible to capture in real-world operations.

Additionally, the training dataset may include detailed textual descriptions of mechanical conditions, provided by expert maintenance personnel and engineers. These textual descriptions can serve multiple purposes: they help establish the vocabulary and structure for the generated technical captions, provide context for image interpretation, and capture subtle diagnostic indicators that might not be immediately apparent in visual data alone. The combination of images, synthetic data, and expert textual descriptions enables the first generative AI model (122) to develop comprehensive capabilities in translating visual observations into meaningful technical assessments.

Such a training dataset allows ensuring the system's ability to generate accurate and relevant technical captions across a wide range of operational conditions and equipment types. It enables the generative AI model to recognize and describe both common and rare mechanical conditions, ensuring comprehensive coverage in the system's monitoring capabilities.

Optionally, a fault dataset utilized for training the second generative AI model (124) encompasses multiple complementary data sources designed to enable comprehensive anomaly detection capabilities. This dataset optionally includes historical fault data collected from actual equipment failures, providing real-world examples of how various mechanical issues manifest and progress. Such historical data captures the subtle indicators and progression patterns of different failure modes, enabling the generative AI model to recognize similar patterns in early stages. The fault dataset can be further enhanced with synthetic fault descriptions generated through advanced simulation models. These synthetic descriptions expand the model's capability to recognize potential failure modes that may be rare or have not yet occurred in documented historical data. This synthetic data generation approach may be particularly useful for new equipment types or novel operational conditions where historical fault data may be limited. The dataset may also incorporate predefined anomaly patterns established through engineering analysis and expert knowledge. These patterns may represent known failure modes, wear characteristics, and performance degradation sequences that have been identified through theoretical analysis, laboratory testing, or field experience. By including these predefined patterns, the generative AI model can recognize and classify anomalies even when they don't exactly match historical fault cases.

Additionally or alternatively an operational action dataset represents a comprehensive catalog of known valid, authorized, and expected operational patterns is used. This dataset can include verified instances of normal operations, authorized access patterns, and/or confirmed proper system behaviors. It may incorporate reference data from successful equipment operations, standard maintenance procedures, and typical performance metrics. The dataset can be enhanced with synthetic examples generated through operational simulations and process modeling. This approach may enable the AI model to accurately validate legitimate operations while flagging deviations from established normal patterns for further investigation.

In some embodiments, the combination of historical fault data, synthetic fault descriptions, and optionally predefined anomaly patterns creates a robust foundation for the second generative AI model (124) to accurately identify and classify mechanical anomalies across a broad spectrum of operational scenarios and failure modes. This comprehensive training approach may enable the system to recognize both common and rare fault conditions, ensuring reliable anomaly detection capabilities.

In certain embodiments, the processor (120) executes an analysis to calculate the likelihood of mechanical failure of the operational mechanism (102). This calculation integrates multiple data streams to provide a comprehensive risk assessment. Specifically, the module may consider the identified mechanical anomalies, current environmental sensor data, predetermined operational schedules, and/or historical maintenance data of the operational mechanism.

The analysis may employ algorithms to weigh these various inputs and generate a quantified probability of failure. For instance, when evaluating identified mechanical anomalies, the system may consider not only their severity but also their rate of progression. Environmental sensor data, such as temperature, humidity, vibration levels, and/or other ambient conditions, may provide context for how external factors might accelerate or influence the progression of detected anomalies. The system may correlate this with predetermined operational schedules to assess how planned usage patterns might impact the progression of identified issues.

The historical maintenance data may provide context for the analysis, allowing the system to consider how similar conditions have evolved in the past and what maintenance interventions were successful or unsuccessful. This historical perspective may enhance the accuracy of the failure likelihood calculations.

Based on the calculated likelihood of mechanical failure, the processor (120) may be further configured to automatically adjust control parameters through an adaptive control. These adjustments are designed to maintain safe operation while minimizing the risk of failure. For example, when the calculated failure likelihood exceeds certain thresholds, the system might automatically reduce operational loads, modify duty cycles, or implement compensatory control strategies to extend the safe operating window until maintenance can be performed.

According to some embodiments, this predictive capability, combined with automated control parameter adjustment, represents an approach to proactive maintenance management, enabling optimization of operational parameters optionally in real-time.

The processor (120) may execute a severity assessment configured to determine a quantitative severity level of identified mechanical anomalies. This determination

employs a multi-factor analysis approach that considers several critical parameters. As used herein, a ‘quantitative severity level’ refers to a numerical assessment of the criticality of detected mechanical anomalies, calculated based on measured deviations from baseline parameters, potential impact on mechanical functions, and environmental conditions, expressed on a standardized scale that enables consistent evaluation and response prioritization.

First, it may evaluate measured deviations from the baseline operational parameters, quantifying how far current conditions have strayed from normal operational ranges. As used herein, ‘baseline operational parameters’ refers to a set of reference values and acceptable ranges for mechanical, electrical, thermal, and/or operational characteristics of the operational mechanism, established during normal functioning conditions and optionally updated through machine learning analysis of operational data. These parameters may include, but are not limited to, temperature ranges, vibration levels, pressure values, movement patterns, liquid levels, corrosion levels, crack sizes, element deviations. performance metrics or others specific to the operational mechanism type.

Second, it may assess the detected impact on mechanical functions of the operational mechanism (102), analyzing how the anomalies affect actual performance and operational capabilities.

Third, it may incorporate real-time environmental condition measurements, considering how ambient conditions might influence or exacerbate the detected anomalies. As used herein, ‘real-time’ refers to processing and analysis performed within a time period that allows for meaningful response to changing conditions of the operational mechanism, where the maximum acceptable time period is determined by the specific application requirements and the nature of the monitored mechanism. For example, real time analysis may refer to analysis that enables alert before failure occurs, or analysis that enables alert during operation of the operation mechanism or analysis within a time frame that enables a technician to instruct taking images and receiving analysis during routine check-up. For critical safety applications, this may be within milliseconds, while for general maintenance monitoring, this may be within seconds or minutes. As used herein, a ‘mechanical anomaly’ refers to any deviation from expected mechanical behavior, physical condition, and/or operational performance that exceeds predefined thresholds or patterns identified through AI analysis as potentially indicative of developing mechanical issues. This includes but is not limited to structural deformations, wear patterns, thermal variations, vibration changes, deviation in movement patterns, leaks and/or the presence of foreign object.

Working in conjunction with the severity assessment, optionally a threshold modification logic automatically modifies operational thresholds of the operational mechanism (102) based on the determined quantitative severity level. This automatic threshold modification may serve as a proactive measure to prevent mechanical failure. The modification process may use algorithms to calculate appropriate new thresholds that balance operational requirements with equipment protection.

For example, if the severity assessment indicates moderate bearing wear with increasing vibration patterns, the system might progressively lower speed thresholds or modify load limits to reduce stress on the affected components. Similarly, if structural stress patterns are detected, the system could adjust acceleration limits or modify operational envelopes to prevent further degradation. These threshold modifications can be dynamically updated based on continuous severity level assessments, ensuring that operational parameters remain optimized for current conditions.

According to some embodiments, this combination of quantitative severity assessment and automatic threshold modification provides an approach to equipment protection, enabling fine-tuned responses to developing mechanical issues before they progress to failure conditions.

The system (100) may further incorporate advanced severity reporting capabilities through a dedicated severity analysis and presentation subsystem. Similar to the previously described severity assessment capabilities, the processor (120) determines a quantitative severity level of identified mechanical anomalies through multi-parameter analysis. This analysis may consider measured deviations from baseline operational parameters, evaluate detected impacts on mechanical functions of the operational mechanism (102), and/or incorporate real-time environmental condition measurements to provide a comprehensive severity assessment.

However, in this implementation, the processor (120) is specifically configured to automatically instruct the presentation of the determined quantitative severity level through the presentation unit (130). The presentation subsystem includes specialized visualization components that translate the complex severity calculations into actionable information displays. These displays may include color-coded severity indicators, trend analysis graphs, and/or comparative baseline deviation metrics.

The severity presentation can be customized based on the viewer's role and technical expertise. For example, maintenance personnel might receive detailed technical breakdowns of the severity metrics, while operational commanders might see high-level status indicators with clear decision-support information. The system can also generate different visualization formats such as real-time dashboards, detailed technical reports, or simplified status summaries, all derived from the same underlying severity assessment data.

The processor (120) may execute a maintenance alert generation logic to generate comprehensive maintenance alerts with multiple critical components. These maintenance alerts integrate various data elements to provide a complete picture of the mechanical issue and required response. Specifically, each maintenance alert may include technical specifications of the identified mechanical anomalies, providing detailed information about the nature and location of detected issues. The alerts may also incorporate real-time sensor data indicating the severity level of the mechanical anomalies, enabling maintenance personnel to understand the urgency and scope of the required response.

Optionally, a time-to-failure prediction is calculated based on current operational data and used for timing an alert or in the generated alert. This prediction may be generated by a specialized predictive analysis that considers the progression rate of detected anomalies, current operating conditions, and/or historical failure patterns. As used herein, a ‘time-to-failure prediction’ refers to a calculated estimate of the remaining operational time before a detected mechanical anomaly is likely to result in component or system failure, based on current operational data, historical failure patterns, environmental conditions, and/or planned operational schedules.

In some embodiments, each alert also includes detailed maintenance procedures required to restore normal operation, generated by a maintenance procedure compilation component that draws from technical documentation and/or maintenance histories.

Optionally, the alert is a dual-path alert. In one path, the maintenance alert is automatically added to the maintenance notification displayed on the presentation unit (130), ensuring immediate visibility to on-site personnel. In the parallel path, the alert is automatically transmitted to a maintenance control system to initiate predictive maintenance procedures. This dual-path approach may ensure higher awareness and systematic integration with broader maintenance management systems.

The alerts maybe used for coordinating resources, schedule maintenance activities, and/or track the resolution of identified issues. This integration enables a seamless transition from anomaly detection to maintenance execution, minimizing response times and optimizing resource allocation.

Optionally, a time-to-failure prediction is generated with projections based on current operational data. This prediction maybe calculated based on real-time operational parameters, degradation rates, and/or environmental conditions to calculate precise estimates of remaining operational time before potential failure occurs.

The calculated time-to-failure prediction may be prominently featured in the maintenance notification displayed by the presentation unit (130). The prediction may be continuously updated based on incoming sensor data and operational conditions, providing dynamic assessment of the system's projected operational timeline, optionally in real-time. The presentation of this prediction optionally includes not only the estimated time remaining but also confidence intervals and key factors influencing the prediction. To enhance its accuracy, the time-to-failure prediction module may incorporate multiple data streams, including:
Current degradation rates of affected components;
Historical failure patterns from similar conditions;
Environmental impact factors;
Current operational load profiles;
Maintenance history of the specific component;
System interdependency analysis; and/or
inputs from external sensors, components of the system, and/or further AI models.
   This time-to-failure prediction may enable maintenance planners and operators to make informed decisions about maintenance scheduling and operational adjustments, helping to optimize both maintenance resources and operational availability.

Optionally, a future conditions analysis that extends the predictive capabilities beyond current operational states is conducted. This analysis is specifically configured to predict when the identified mechanical anomalies are likely to lead to mechanical failure based on known future environmental parameters and known operational schedules.

The future conditions analysis incorporates a predictive modeling component that processes multiple forward-looking data streams. This component analyzes scheduled operational requirements, planned mission profiles, and forecasted environmental conditions to project how current mechanical anomalies might evolve under future operating conditions. For example, if high-stress operations are scheduled during predicted adverse weather conditions, the system can calculate accelerated degradation scenarios and adjust failure predictions accordingly.

The environmental prediction component may process meteorological forecasts, expected operational environments, and/or seasonal variations that might impact equipment performance. This environmental analysis may include an operational schedule analysis which evaluates planned usage patterns, mission requirements, and/or anticipated load profiles. By combining these predictive capabilities with the anomaly detection features, a comprehensive view of not just current equipment condition may be performed but also likely future states based on known operational plans and environmental forecasts. This forward-looking analysis may enable proactive maintenance planning and mission scheduling adjustments to prevent potential failures before they occur.

Optionally, the system (100) incorporates an adaptive modeling subsystem that generates and maintains a dynamic model of proper mechanism functioning. This subsystem performs a baseline model generation that processes the plurality of images to establish comprehensive performance models of the operational mechanism under normal operating conditions. The adaptive modeling subsystem may implement a periodic retraining mechanism that continuously refines and updates these models using images collected during actual operation of the operational mechanism. This retraining process may enable the system to adapt to gradual changes in operational characteristics, environmental conditions, and equipment behavior over time. The periodic retraining can help maintain generative AI model accuracy and relevance as equipment ages and operating conditions evolve.

The retraining process optionally incorporates data validation that ensures the quality and relevance of new training data, filtering out anomalous or non-representative operational states. The model optimization may be performed by integrating the validated new data with existing baseline models, adjusting model parameters to reflect current operational realities while maintaining the fundamental understanding of proper mechanical function. This continuous learning and adaptation capability may enable the system to maintain high detection accuracy throughout the operational lifetime of the equipment, automatically accounting for normal wear patterns, environmental variations, and changes in operational requirements. The dynamic nature of these models may ensure that anomaly detection remains accurate and relevant even as the operational mechanism and its operating environment evolve over time. As used herein, ‘model optimization’ refers to the process of refining and improving the performance of the generative AI models through periodic retraining, parameter adjustment, and integration of new operational data, while maintaining accuracy in mechanical condition assessment and anomaly detection.

Optionally, the system (100) is further designed to forecast failure progression based on comprehensive future state analysis. Similar to previously described predictive capabilities, forecast failure progression implements additional specialized components for more detailed future state modeling.

In certain embodiments, the processor (120) executes a mission profile analysis to examine detailed operational schedules to identify high-stress periods, usage patterns, and/or potential cumulative stress factors. This component may work in conjunction with an environmental impact modeling that processes detailed environmental forecasts to assess how future conditions might accelerate or modify the progression of identified anomalies.

The analysis may be based on a temporal correlation engine which aligns predicted environmental conditions with planned operational schedules to identify potential high-risk periods where multiple stress factors might coincide. The engine generates time-based risk profiles that highlight periods where the combination of operational demands and environmental conditions might accelerate the progression of identified anomalies toward failure. The mission profile analysis may utilize probability modeling to generate confidence intervals for different failure scenarios based on the interaction between identified anomalies, planned operations, and/or predicted environmental conditions. This probabilistic approach may enable more nuanced risk assessment and operational planning, accounting for uncertainties in both environmental predictions and operational schedules.

In certain embodiments, the processor (120) generates operating instructions tailored to respond to detected fault conditions. These operating instructions may be automatically included in the maintenance alerts.

Optionally, operating instructions comprises abort instructions that establish quantitative thresholds for terminating operation of the operational mechanism (102). These abort operations (e.g., criteria) are dynamically generated based on the specific nature and severity of detected fault conditions, incorporating safety margins appropriate to the current operational context and potential failure modes.

Optionally, operating instructions have modifiable parameters having detailed specifications for continued operation until maintenance can be performed. These modifiable parameters are carefully calculated to balance operational requirements with equipment protection, specifying adjusted operational limits, modified performance envelopes, and/or compensatory control settings. The operating instructions may consider specific characteristics of detected anomalies to establish operational parameters that minimize further degradation while maintaining essential functionality.

Optionally, operating instructions provide emergency response protocols. These procedures can be specifically tailored to the detected fault condition and current operational context, providing step-by-step guidance for handling critical situations. The emergency procedures may include specific actions required to safely manage the fault condition, protect personnel and equipment, and/or minimize potential damage or operational impact.

Optionally, the operating instructions have context-aware formatting to provide instructions in a clear, unambiguous format appropriate to the urgency of the situation and the intended audience. This component can generate different versions of the instructions optimized for various user roles, from technical maintenance personnel to operational commanders, while maintaining consistency in the underlying response protocols.

Reference is now made to an exemplary implementation. The processor (120) implements a sequential dual-model artificial intelligence pipeline specifically configured for mechanical condition analysis. The processing pipeline operates through coordinated execution of the first and second generative models as detailed herein.

The first generative artificial intelligence model (122) may be configured to perform image-to-text or video-to-text conversion with specific focus on mechanical and/or industrial contexts. The generative AI model implementation may execute input processing comprising image normalization to standard resolution and format, optionally followed by extraction of relevant image regions based on predefined mechanical focus areas, and subsequent application of enhancement filters optimized for mechanical detail preservation.

For caption generation, the first model produces structured output comprising component identification and optionally condition description, observable state changes, environmental factors, and/or detected anomalies or foreign objects. The model may enforce technical vocabulary constraints ensuring use of standardized mechanical terminology while preserving spatial relationships in descriptive output. As used herein, a ‘foreign object’ refers to any unexpected item, material, or debris detected in proximity to the operational mechanism that is not part of its intended design or operation, including but not limited to maintenance tools, debris, biological matter, or detached components, which may or may not pose operational risks.

The second generative artificial intelligence model (124) may be specifically configured for technical analysis of structured mechanical descriptions. The generative AI model may perform input processing through parsing of structured captions into analyzable segments, extraction of key technical parameters and observations, and classification of described conditions into predefined categories.

For anomaly detection, the second model may execute pattern matching against known fault conditions and/or deviation analysis from baseline parameters. The second generative AI model may perform severity assessment based on component criticality, deviation magnitude, rate of change, environmental context, and/or operational impact. The implementation architecture may support both synchronous and asynchronous processing modes. In synchronous mode, the system performs image analysis with immediate caption generation and anomaly detection, providing direct feedback to control systems, optionally in real-time.

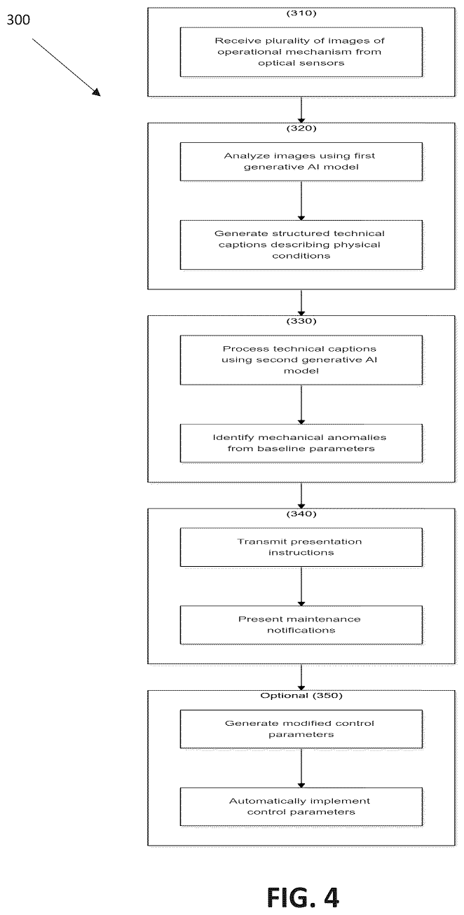

In asynchronous mode, the system executes batch processing of collected images with detailed analysis and extended processing time allocation, enabling historical trend analysis and integration with maintenance scheduling systems. The implementation may utilize specific data structures for inter-model communication. A caption data structure may comprise timestamp in ISO8601 format, component identifier, three-dimensional location coordinates, structured observations including type, description, confidence values, environmental factors including factor identification, numerical values, and/or units. An anomaly data structure may comprise anomaly identifier, type classification, severity quantification, confidence measure, affected component identifiers, recommended actions with priority levels and timeframes, and/or operational impact assessment including severity metrics and descriptive analysis. The implementation may incorporate a model update interface enabling versioned model deployment, hot-swapping of model weights, and/or performance monitoring and validation. A training pipeline may enable continuous learning from verified results, transfer learning for new component types, and/or automated performance optimization. The integration interface may provide standard REST API endpoints, WebSocket support for monitoring, and secure data transmission protocols. The system implements comprehensive error handling for image quality issues through blur detection and correction, lighting compensation, and noise filtering. The implementation may enforce model confidence thresholds comprising minimum confidence requirements for anomaly reporting, uncertainty quantification in analysis results, and fallback procedures for low-confidence scenarios. System health monitoring tracks model performance metrics, processing time parameters, and resource utilization optimization. In certain embodiments, the caption data structure may be implemented according to the following specification. The timestamp field utilizes standardized ISO8601 formatting to ensure precise temporal recording of observations. The component identifier employs a hierarchical naming convention enabling systematic identification of subcomponents within complex mechanical assemblies. The location coordinates are recorded in floating-point format with millimeter precision, referenced to a defined origin point within the operational mechanism. Optionally, condition description for caption data within the caption data structure contains multiple entries, each comprising a standardized type identifier selected from a predefined taxonomy of mechanical conditions, a detailed textual description adhering to controlled vocabulary constraints, and a confidence value expressed as a normalized floating-point number between 0 and 1. The environmental factors records ambient conditions that may affect mechanical performance or sensor readings. Each factor entry may include a standardized identifier, a numerical value in floating-point format, and a standardized unit identifier conforming to international measurement standards. The anomaly data structure may implement a comprehensive representation of detected mechanical issues. The anomaly identifier employs a unique naming scheme incorporating temporal and spatial reference data. The type classification adheres to a hierarchical taxonomy of mechanical faults, enabling systematic categorization of detected issues. The severity quantification may utilize a normalized scale from 0 to 1, with defined thresholds for different operational impact levels. The confidence measure employs the same normalized scale, reflecting the system's certainty in the anomaly detection and classification. The recommended actions may contain prioritized intervention steps, with priority levels ranging for example from 1 to 5, and timeframes specified in standardized duration format. The operational impact assessment may include both a normalized severity metric and a structured description of potential consequences. Referring now to FIG. 4, which illustrates a flowchart of a computer-implemented method (300) for predictive maintenance of the operational mechanism (102), according to some embodiments of the present invention. The method (300) may be implemented either locally on an end device positioned proximate to the operational mechanism (102), or remotely in a cloud computing environment, or in a hybrid configuration utilizing both local and cloud processing capabilities.

In a local implementation, the method (300) is executed by the processor (120) installed optionally within an enclosure, for instance ruggedized enclosure, near the operational mechanism (102). The local implementation may enable real-time processing with minimal latency, thereby reducing the need for high bandwidth usages. In a cloud implementation, the method (300) is executed on remote servers, and may allow for more computational resources and cross-system analysis capabilities, with image and sensor data transmitted via secure network connections.

The method (300) comprises the following operations:

At (310), the processor (120) receives a plurality of images of at least a portion of the operational mechanism (102). These images are captured by the optical sensor(s) (112) and transmitted through the hardware interface (110). The image acquisition can occur in real-time during operation, or before and after operation as previously described.

At (320), the processor (120) employs the first generative artificial intelligence model (122) to analyze the received plurality of images. This analysis step utilizes the training dataset comprising mechanical system images, synthetic data, and/or textual descriptions of mechanical conditions to generate structured technical captions describing physical conditions of the operational mechanism (102).

For example, the generative AI model queried with a prompt for analyzing the received images for labeling all present objects in the operational mechanism, including foreign objects present near it and labeling them. The generative AI model receives one or more images and generates detailed caption of image content optionally including object classification and severity assessment.

At (330), the processor (120) utilizes the second generative AI model (124) to process the generated structured technical captions. The second generative AI model (124) may receive as an input the generated captions and a prompt, such as “analyze the technical caption for potential foreign objects or anomalies. Consider: Object classification, Potential impact on system operation, Required maintenance actions, and Safety implications”. This allows the generative AI model to output analysis result, for instance in the following format:
detection_result={
   ‘caption’: caption,
   ‘detected_objects’: analysis_result.objects,
   ‘severity_assessment’: analysis_result.severity,
   ‘recommended_actions’: analysis_result.actions,
   ‘safety_status’: analysis_result.safety_rating
   }
   return detection_result

This processing step employs the fault dataset comprising historical fault data, synthetic fault descriptions, and/or predefined anomaly patterns to identify mechanical anomalies that deviate from baseline operational parameters of the operational mechanism (102).

At (340), the processor (120) may transmit presentation instructions to the presentation unit (130) configured for presenting a maintenance notification indicative of the mechanical anomalies. The presentation instructions may be transmitted locally to an on-site display device or remotely to cloud-based monitoring interfaces, depending on the implementation architecture.

In the hybrid implementation, certain steps may be distributed between local and cloud processing. For example, initial image processing and urgent anomaly detection might occur locally for immediate response, while more complex analysis and pattern recognition across multiple systems might be performed in the cloud.

The method (300) may be implemented as a continuous loop, with steps (310) through (340) repeatedly executed to provide ongoing monitoring and analysis. The frequency of execution may be adjusted based on operational requirements, processing capabilities, and criticality of the monitored mechanism.

At an optional (350), when mechanical anomalies are identified, the processor (120) executes a dynamic parameter generation process through the control adaptation module (140). This step may involve analyzing the severity and nature of identified anomalies and optionally calculating appropriate operational adjustments and/or generating modified control parameters specific to the current condition, for example as detailed above. The processor (120) may automatically implement these modified control parameters through automatic control implementation. This implementation may comprise validating the safety and feasibility of the modified parameters and/or gradually adjusting operational controls to prevent sudden changes and/or monitoring the effectiveness of the implemented changes as described above. It should be noted that step 350 may be performed with some or all of the functions of (340) or without (340).

Reference is now made to three non-limiting examples of executing the method depicted in FIG. 4 using the system described in FIG. 1.

### USE CASE 1

### Aircraft Landing Gear Monitoring

This use case demonstrates the system's implementation in a critical aviation safety application. The implementation utilizes optical sensors (112) mounted at key points around the landing gear assembly, with local processing implementation prioritized for real-time response. The system employs high-speed thermal and/or structural imaging cameras for comprehensive monitoring.

Following the method flow (300), the image acquisition phase (Step 310) begins with pre-landing imaging to capture the baseline state of the landing gear system. During actual operation, imaging captures the landing impact and gear retraction sequence, optionally followed by post-landing thermal imaging during the cool-down phase.

In the first AI analysis (320), the system generates technical captions describing observed conditions. These might include descriptions such as “Hydraulic damper compression pattern measured at 2.3 Hz with 15 mm amplitude,” “Thermal measurement of 82° C. detected in left strut bearing assembly,” or “Load distribution measurements during gear operations. Detailed technical captions describing observed conditions may be included, for example “Irregular hydraulic damper compression pattern detected during touchdown,” “Thermal hotspot observed in left strut bearing assembly,” or “Asymmetric load distribution identified during gear retraction.”

The anomaly detection phase (Step 330) processes these captions to identify specific issues, such as hydraulic pressure deviations from normal operating parameters, early signs of bearing wear based on structural or thermal patterns, and structural stress patterns during landing impact.

The response implementation phase (Steps 340-350) executes immediate actions based on detected anomalies. The system may issue maintenance notifications for hydraulic system inspection, modify maximum landing weight restrictions, adjust gear deployment and retraction speeds, or recommend alternative landing procedures to reduce stress on affected components.

### USE CASE 2

### Naval System Monitoring

This use case illustrates the system's application in a maritime platform. The implementation features a distributed sensor network covering the engine mount, stirring mechanism, and safety assembly. It employs a hybrid processing implementation, combining local processing for immediate safety concerns with cloud processing for long-term analysis, all utilizing environmental-hardened sensors designed for maritime conditions. The image acquisition phase (Step 310) maintains continuous monitoring with high-speed imaging of engine operation and/or thermal imaging of cooling patterns, complemented by post-acceleration structural analysis imaging. During the first AI analysis (320), the system generates technical captions such as “Uneven thermal distribution observed along the engine body,” and “Microscopic surface pattern changes detected in a stirring mechanism.” The anomaly detection phase (Step 330) identifies specific issues including deviations in timing patterns, wear patterns exceeding normal profiles, and mounting stress distributions. In the response implementation phase (Steps 340-350), the system may also execute various control modifications. These include adjusting maximum firing rate restrictions, modifying recoil damper settings based on wear patterns, implementing modified cooling cycles between firing sequences, or generating specific maintenance schedules based on usage patterns. The aircraft case emphasizes immediate, local processing for safety-critical responses, while the naval case utilizes hybrid processing to balance immediate safety needs with long-term wear analysis. Both implementations demonstrate the system's flexibility in adapting to different operational requirements while maintaining comprehensive monitoring and predictive maintenance capabilities.

### USE CASE 3

### Foreign Object Detection in Critical Areas

This use case demonstrates the system's application in detecting and analyzing foreign objects in sensitive operational areas. The implementation may utilize optical sensors such as high-resolution cameras positioned to monitor critical access points and operational zones, with particular emphasis on areas prone to foreign object accumulation or accidental tool placement during maintenance.

Following the method flow (300), the image acquisition phase captures periodic scans of monitored areas, with increased frequency during and after maintenance activities. The first AI analysis generates detailed captions identifying any foreign objects, such as “Metal screwdriver detected on maintenance platform” or “Spider observed on landing gear assembly.”

The anomaly detection phase analyzes these captions to assess risk levels and required actions. For example, the system might determine that a detected screwdriver requires immediate removal due to its potential to interfere with critical mechanisms, while a spider web might be classified as a lower-priority issue requiring routine cleaning.

The response implementation phase generates specific removal procedures and safety warnings based on the type of foreign object detected. The system can also correlate foreign object detections with maintenance records to identify potential procedural gaps or training needs.

In particular embodiments, the structured technical captions generated by the first generative AI model adhere to a standardized format optimized for mechanical analysis. The structured format may comprise a hierarchical component identification section identifying the specific mechanical assembly, subassembly, and component being described, for example: “Main Landing Gear Assembly>Shock Strut>Lower Bearing Housing” and a quantitative measurements section including specific numerical values with standardized units, for instance: “Surface temperature deviation: +15.3° C. above baseline; Structural displacement: 0.127 mm lateral offset; Vibration amplitude: 2.1× nominal value.”. A spatial reference section utilizing a standardized coordinate system may be added, exemplified as: “Anomaly location: X=127.4 mm, Y=45.2 mm, Z=892.1 mm from reference point Alpha; Affected area: 45.3 mm2.”. A condition assessment section employing standardized terminology may be added, such as: “Category: Thermal Anomaly; Severity: Level 3; Progression Rate: 0.15 mm/operational hour; Pattern Classification: Asymmetric Wear Pattern Type II.”. Environmental context data may be added including: “Ambient Temperature: 22.3° C.; Humidity: 45%; Operating Load: 78% of rated capacity; Cumulative Operational Hours: 1,247.”

It is expected that during the life of a patent maturing from this application many relevant sensors and models will be developed and the scope of the term a generative AI model and an optical sensor is intended to include all such new technologies a priori.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with structured embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the Applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer-implemented system for predictive maintenance of an operational mechanism, comprising:
a hardware interface configured for receiving a plurality of images of at least a portion of the operational mechanism, the plurality of images is captured by at least one optical sensor; and
at least one processor operatively coupled to the at least one optical sensor and configured to:
receive the plurality of images captured by the at least one optical sensor from the hardware interface;
analyze the plurality of images using a first generative artificial intelligence model trained using a training dataset to generate structured technical captions describing physical conditions of the operational mechanism;
process the generated structured technical captions using a second generative artificial intelligence model trained using a fault dataset to identify one or more mechanical anomalies in the operational mechanism, wherein the mechanical anomalies comprise deviations from baseline operational parameters of the operational mechanism;
transmit presentation instructions to a presentation unit configured for presenting a maintenance notification indicative of the mechanical anomalies.

2. The system of claim 1, wherein the at least one processor is further configured to dynamically generate modified control parameters for the operational mechanism based on the identified one or more mechanical anomalies.

3. The system of claim 2, wherein the at least one processor is further configured to automatically implement the modified control parameters to adjust operation of the operational mechanism until completion of a maintenance action, thereby preventing damage to the operational mechanism.

4. The system of claim 1, wherein the training dataset comprises at least one of: mechanical system images, synthetic data, or textual descriptions of mechanical conditions.

5. The system of claim 1, wherein the fault dataset comprises at least one of: historical fault data, synthetic fault descriptions, or predefined anomaly patterns.

6. The system of claim 1, wherein the at least one processor is further configured to: calculate a likelihood of mechanical failure of the operational mechanism based on one or more of: the identified one or more mechanical anomalies, current environmental sensor data, a predetermined operational schedule, and historical maintenance data of the operational mechanism; and automatically adjust control parameters based on the calculated likelihood of mechanical failure to maintain safe operation of the operational mechanism.

7. The system of claim 1, wherein the at least one processor is further configured to:
determine a quantitative severity level of the identified one or more mechanical anomalies based on one or more of: measured deviations from the baseline operational parameters, detected impact on mechanical functions of the operational mechanism, and environmental condition measurements; and
automatically modify operational thresholds of the operational mechanism based on the determined quantitative severity level to prevent the mechanical failure.

8. The system of claim 1, wherein the at least one processor is further configured to:
determine a quantitative severity level of the identified one or more mechanical anomalies based on one or more of:
measured deviations from the baseline operational parameters,
detected impact on mechanical functions of the operational mechanism, and
environmental condition measurements; and
automatically instruct a presentation of the determined quantitative severity level.

9. The system of claim 1, wherein the at least one processor is further configured to:
generate a maintenance alert comprising:
technical specifications of the identified one or more mechanical anomalies,
sensor data indicating a severity level of the mechanical anomalies
a calculated time-to-failure prediction based on current operational data, and
maintenance procedures required to restore normal operation; and
at least one of automatically add the maintenance alert to the maintenance notification, and automatically transmit the maintenance alert to a maintenance control system to initiate predictive maintenance procedures.

10. The system of claim 1, wherein:
the first generative AI model is trained to identify foreign objects in proximity to the operational mechanism;
the structured technical captions include descriptions of detected foreign objects;
the second generative AI model is configured to assess risk levels associated with detected foreign objects; and
the maintenance notification includes foreign object removal procedures.

11. The system of claim 1, wherein the at least one processor is further configured to:
predict when the identified one or more mechanical anomalies are likely to lead to a mechanical failure based on known future environmental parameters and a known operational schedule.

12. The system of claim 1, wherein the at least one processor is further configured to:
generate a model of proper mechanism functioning based on the plurality of images; and
periodically retrain the model using images collected during actual operation of the operational mechanism.

13. The system of claim 1, wherein the at least one processor is further configured to:
predict when the identified one or more mechanical anomalies are likely to lead to failure based on known future environmental parameters and a known operational schedule.

14. The system of claim 9, wherein the maintenance alert includes operating instructions specific to a detected fault condition, wherein the operating instructions comprise at least one of:
abort criteria for operation of the operational mechanism,
modified operational parameters for continued operation until maintenance is performed, or
emergency procedures.

15. The system of claim 1, further comprising:
a baseline model generation component that establishes initial performance models;
a periodic retraining mechanism that updates the models using operational data;
a data validation component that ensures training data quality; and
a model optimization component that integrates new data while maintaining baseline understanding.

16. The system of claim 1, wherein the plurality of images are real time images captured during an operation of the operational mechanism.

17. A computer-implemented method for predictive maintenance of an operational mechanism, the method comprising:
receiving, by at least one processor, a plurality of images of at least a portion of the operational mechanism, the plurality of images captured by at least one optical sensor;
analyzing, by the at least one processor, the plurality of images using a first generative artificial intelligence model trained using a training dataset to generate structured technical captions describing physical conditions of the operational mechanism;
processing, by the at least one processor, the generated structured technical captions using a second generative artificial intelligence model trained using a fault dataset to identify one or more mechanical anomalies in the operational mechanism, wherein the mechanical anomalies comprise deviations from baseline operational parameters of the operational mechanism;
transmitting, by the at least one processor, presentation instructions to a presentation unit configured for presenting a maintenance notification indicative of the mechanical anomalies.

18. The method of claim 17, further comprising:
dynamically generating modified control parameters for the operational mechanism based on the identified one or more mechanical anomalies; and
automatically implementing the modified control parameters to adjust operation of the operational mechanism until completion of a maintenance action, thereby preventing damage to the operational mechanism.

19. The method of claim 17, wherein the plurality of images are real time images captured during an operation of the operational mechanism.

20. The method of claim 17, wherein the training dataset comprises at least one of: mechanical system images, synthetic data, or textual descriptions of mechanical conditions.

21. The method of claim 17, wherein the fault dataset comprises at least one of: historical fault data, synthetic fault descriptions, or predefined anomaly patterns.

22. The method of claim 19, further comprising:
calculating a likelihood of mechanical failure of the operational mechanism based on one or more of: the identified one or more mechanical anomalies, current environmental sensor data, a predetermined operational schedule, and historical maintenance data of the operational mechanism; and
automatically adjusting control parameters based on the calculated likelihood of mechanical failure to maintain safe operation of the operational mechanism.

23. The method of claim 17, further comprising:
determining a quantitative severity level of the identified one or more mechanical anomalies based on one or more of: measured deviations from the baseline operational parameters, detected impact on mechanical functions of the operational mechanism, and environmental condition measurements; and
automatically modifying operational thresholds of the operational mechanism based on the determined quantitative severity level to prevent the mechanical failure.
